(19) United States
(12) Patent Application Publication
(10) Pub. No.: US 2004/0091338 A1
(43) Pub. Date: May 13, 2004

(54) Transfer system and apparatus for workpiece containers and method of transferring the workpiece containers using the same

(76) Inventor: Ki-Sang Kim, Yongin-city (KR)

Correspondence Address: MYERS BIGEL SIBLEY & SAJOVEC, PO BOX 37428, RALEIGH, NC, 27627, US

(21) Appl. No.: 10/701,322

(22) Filed: Nov. 4, 2003

Related U.S. Application Data
(62) Division of application No. 09/829,226, filed on Apr. 9, 2001.
(60) Provisional application No. 60/215,040, filed on Jun. 29, 2000.

(30) Foreign Application Priority Data
Apr. 12, 2000 (KR) 2000-19374
Jan. 29, 2001 (KR) 2001-4086

(51) Int. Cl. B65G 1/00

(52) U.S. Cl. 414/217

(57) ABSTRACT

An apparatus for transferring a container stored with a workpiece (for example, a semiconductor wafer container) between manufacturing stations includes: a manufacturing station that includes a generally horizontal support platform; one or more guides for guiding a vehicle; a vehicle configured to travel on one or more guides to a position below support platform; and a vertical translation unit attached to one of the manufacturing station and the vehicle that vertically translates the container between a lowered position beneath the support platform and a raised position above the support platform. In this configuration, the apparatus can provide a relatively narrow work bay while still allowing sufficient room for a worker. Also, because the vehicle can operate below the level of the manufacturing stations, there is no need for special mounting on the ceiling of the factory.

### RELATED APPLICATIONS

This application is a divisional of U.S. patent application Ser. No. 09/829,226; filed Apr. 9, 2001, which claims the benefit of U.S. Provisional Application No. 60/215,040 filed on Jun. 29, 2000. The contents of these applications are hereby incorporated by reference herein.

### FIELD OF THE INVENTION

The present invention relates generally to a manufacturing system for semiconductor wafers, and more particularly to a transfer apparatus for transferring a container of wafers between processing devices.

### BACKGROUND OF THE INVENTION

When being manufactured, semiconductor devices are typically subjected to a variety of processes such as photolithography, deposition, etching and a thin-film formation. In order to perform the foregoing processes, often a plurality of wafers (usually 25 wafers) are transferred while loaded within a container. The container retaining the wafers therein is transferred between processing stations manually by an operator or by an unmanned automatic transfer system.

To keep up with advancing technology, wafer diameter is being increased from 8 to 12 inches. The 12-inch wafer has a larger footprint area than that of an 8-inch wafer; a container of 25 wafers weighs about 20 kgs, thus rendering manual transfer quite laborious. Therefore, it is understandable that a mass process line which uses the 12-inch wafer increasingly would desirable employ an unmanned transfer system.

Containers retaining wafers therein have typically employed an open wafer cassette for 8inch wafers, but, recently, a closed-type container known as a front open unified pod (hereinafter referred to as a “FOUP”) has been employed. A FOUP can be effective in preventing contamination which arises during the transfer process of wafers. FOUPs have been customary for use with unmanned transfer systems.

Two general types of automated transfer systems are known: an overhead transfer or overhead conveyor (hereinafter referred to as “OHT” or “OHC”); and an automatic guided vehicle system (“AGV” or “RGV”). These are described below.

The OHT (or OHC) system, as shown in FIG. 1, utilizes the space above the processing stations to transfer FOUPs. An OHT system is formed such that linear rails 18a and 18b are installed on the ceiling of a processing facility and hangers 22a and 22b are mounted to the linear rails 18a and 18b. A FOUP 20a is suspended under hanger 22a and is positioned-to be moved along linear rail 18a and is loaded on a FOUP index 16a (ie., a load port) of a designated processing device. Also, a FOUP 20b is positioned on a FOUP index 16b to be drawn upwardly therefrom and moved over another designated processing device along linear rail 18b. An exemplary OHT system has been proposed in U.S. Pat. No. 5,927,472 entitled “Conveyor Transfer Unit.” In an OHT system, because the upper space of FOUP indices 16a and 16b is utilized for movement of the FOUPs between processing stations, an interval W1 between the load ports FOUP indices or a width B1 of the bays can be relatively small to assist in space compactness or space utilization of the facility.

However, the OHT system installed on the ceiling of a clean room bay can be disadvantageous. First, a powerful structural member should be installed on the ceiling due to the weight of a 12 inch wafer FOUP; also, the weight may necessitate the installation of safety devices. Second, when considering that the general height of the clean room is approximately 4 m, the installation height of the OHT system is sufficient that a ladder may be required for performing maintenance or to inspect the FOUP. Third, if an electric power source fails or is otherwise non-operational, it is very difficult for an operator to manually transfer the heavy FOUP from that height. Fourth, the typical distance between the FOUP index and the OHT is large enough to require considerable time for loading/unloading of the FOUP. The above-described problems may be sufficient to adversely impact or even negate the advantages, i.e., compactness of the facility, of the OHT system.

As shown in FIG. 2, an AGV system transfers FOUPs 20a and 20b from automatic guidance vehicles 32a and 32b having a multi-axial joints. The vehicles 22a and 22b load/unload FOUPs 20a and 20b onto/from FOUP indices 16a and 16b of the designated processing device. An exemplary AGV system has been proposed in U.S. Pat. No. 5,332,013 entitled “Unmanned Conveying Device in Clean Room.”

However, the AGV system has some drawbacks. First, the width W2 of the bay shown in FIG. 2 includes load ports 16a and 16b of the devices on opposed sides within the bay, a space which allows (a) two AGVs to execute the loading/unloading operations by being positioned in parallel with each other and (b) a worker moving space between two AGVs. As such, additional space is required beyond that needed for an OTH system. Second, the simultaneous operation by the worker and transfer robot, i.e., AGV, within the bay can increase safety risk. Third, because of the use of multi-axial robot, the AGV is large (or heavy), such that the traveling speed may be limited. Fourth, in case of a 12-inch wafer, the transportable number of the FOUPs per AGV is limited due to the size thereof; this can increase capital costs, as the cost of each AGV is is typically high.

### SUMMARY OF THE INVENTION

The present invention can address some of the shortcomings of the prior art. As a first aspect, the present invention is directed to an apparatus for transferring a container stored with a workpiece (for example, a semiconductor wafer container) between manufacturing stations. The apparatus comprises: a manufacturing station that includes a generally horizontal support platform; one or more guides for guiding a vehicle; a vehicle configured to travel on one or more guides to a position below support platform; and a vertical translation unit attached to one of the manufacturing station and the vehicle that vertically translates the container between a lowered position beneath the support platform and a raised position above the support platform. In this configuration, the apparatus can provide a relatively narrow work bay while still allowing sufficient room for a worker. Also, because the vehicle can operate below the level of the manufacturing stations, there is no need for special mounting on the ceiling of the factory.

In one embodiment, the vertical translation unit is attached to the vehicle, and the support platform includes a cut-out portion through which the vehicle can raise the container. The cut-out portion may be a window within an otherwise solid platform, or can be the space between two arms of a substantially U-shaped member. In some embodiments, retractable pins are present that enable the container to pass through the cut-out portion when the pins are retracted and prevent passage of the container (i.e., the pins support the container from below) when the pins are extended.

As a second aspect, the present invention is directed to a method for transferring a container that stores semiconductor wafers between manufacturing stations. The method comprises the steps of: transporting a vehicle loaded with a container to a predetermined location below a horizontal support platform of a manufacturing station, the movement of the vehicle being controlled by guides; raising the container to a raised position above the support platform; and capturing the container at an operating elevation located below the raised position. Like the aforementioned apparatus, the method enables the transfer of the container in a relatively narrow space and operations can occur below the level of the wafer inlet.

As a third aspect, the present invention is directed to an apparatus for transferring a container that utilizes a horizontal conveyor upon which the container is conveyed. The apparatus comprises: a horizontal conveyor positioned adjacent and below the wafer inlet of each processing station and extending in a horizontal x-direction; a vertical conveyor positioned adjacent the wafer inlet of each processing station and being configured to convey the wafer container substantially vertically along a z-axis between a position on the horizontal conveyor and the wafer inlet; and a controller operably associated with the horizontal and vertical conveyors to control the position of the wafer container. In a preferred embodiment, the apparatus also includes a y-axis conveyor to transport the container from a raised position into the wafer inlet.

The z-axis conveyor may include a pair of vertically-oriented screws that serve to raise a pair of gripping arms, a pair of hydraulic piston units that raise the gripping arms by extending their piston rods, or a retractable suction head.

As a fourth aspect, the present invention is directed to method of loading a container utilizing the horizontal conveyor noted above. This method comprises the steps of: conveying the wafer container along a horizontal x-axis to a position below a wafer inlet and adjacent a loading apparatus associated with the processing station; conveying gripping arms of the loading apparatus to a lowered position below the wafer container; gripping the wafer container with the gripping arms; and raising the wafer container to a raised position at a level at least as high as the wafer inlet. In a preferred embodiment, the method includes the step of conveying the container along the y-axis to insert the container in the wafer inlet.

### BRIEF DESCRIPTION OF THE DRAWINGS

The above objects and other advantages of the present invention will become more apparent by describing in detail preferred embodiments thereof with reference to the attached drawings in which:

FIG. 1 is an end view of a conventional OHT or OHC system transferring wafer containers;

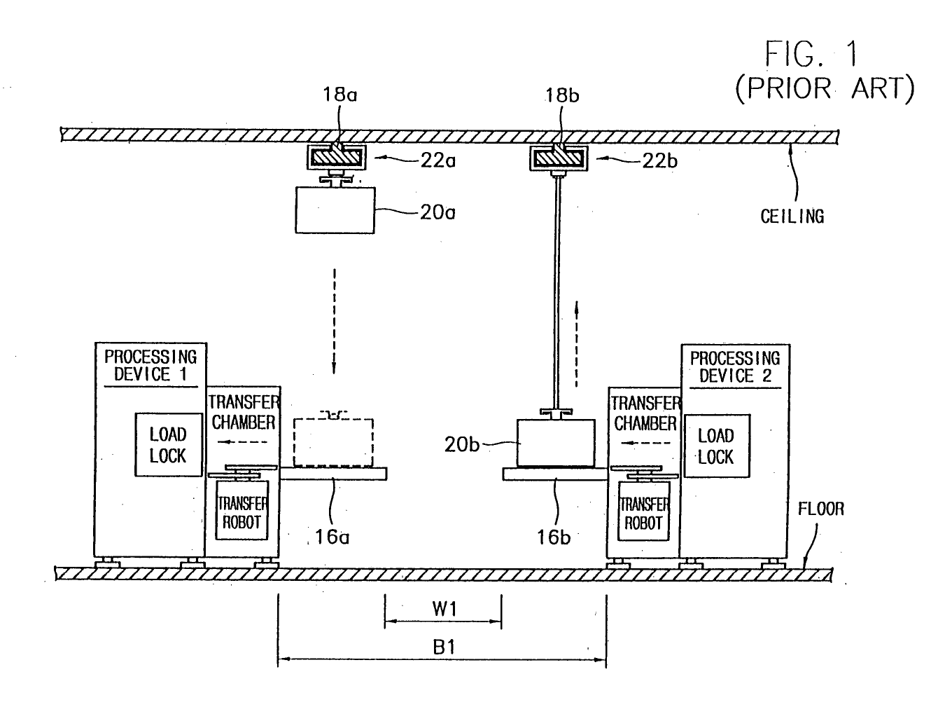

FIG. 2 is an end view of a conventional AGV system transferring wafer containers;

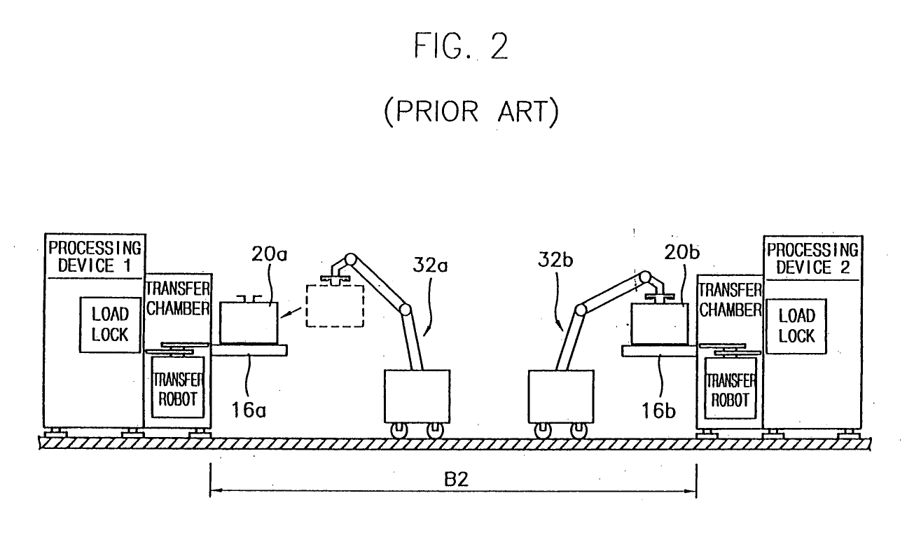

FIG. 3 is a schematic perspective view of an unmanned transfer system installed a manufacturing bay according to a preferred embodiment of the present invention;

FIG. 4 is an end section view taken along line A-A of FIG. 3 for illustrating the installation position of the FOUP index, guide rails and transport shuttle;

FIG. 5A is a perspective view of a FOUP index and transport shuttle according to a first embodiment of the present invention.

FIG. 5B is a front section view of the transport shuttle and FOUP index of FIG. 5A taken along line B-B therein;

FIG. 5C is a top section view taken along line C-C of FIG. 5B;

FIG. 6A is a perspective view of another embodiment of a FOUP index and transport shuttle according to a second embodiment of the present invention;

FIG. 6B is a front section view taken of the transport shuttle and FOUP index of FIG. 6A taken along line B-B thereof;

FIG. 7A is an end section view of a transport shuttle of the present invention provided with a support stand in the form of a vertical double step;

FIG. 7B is a top section view of the shuttle of FIG. 7A;

FIG. 8A is a schematic perspective view of a manufacturing bay of the present invention showing the transfer of a FOUP from one manufacturing station to another;

FIG. 8B is a front view of a transport shuttle loaded with a FOUP with the transport shuttle lifting the FOUP to a height above the FOUP index;

FIG. 8C is a partial front view of the shuttle and FOUP of FIG. 8B with the FOUP being lowered through the FOUP index;

FIG. 8D is a front view of the shuttle of FIG. 8C loaded with a FOUP in a lowered position;

FIG. 8E is a front section view of the FOUP index of FIG. 8B with its retaining pins extended;

FIG. 9 is a flow chart for illustrating the sequential procedure of the process of loading a transport shuttle;

FIG. 10A is a schematic perspective view of a manufacturing bay showing the transfer of a FOUP from one manufacturing station to another;

FIG. 10B is a front section view of a FOUP index with its retaining pins in their retracted positions;

FIG. 10C is a front view of a transport shuttle loaded with a FOUP with the transport shuttle lifting the FOUP to a height above a FOUP index and the retaining pins retracted;

FIG. 10D is a front view of the transport shuttle loaded with a FOUP of FIG. 10C with the FOUP being lowered onto the FOUP index, which has its retaining pins extended;

FIG. 10E is a front view of the transport shuttle and FOUP index of FIG. 10B with the FOUP index loaded and the transport shuttle in a lowered position;

FIG. 11 is a flow chart for illustrating the sequential procedure of the process of unloading a transport shuttle;

FIGS. 12A, 12B and 12C are plan view of exemplary guide rail arrangements;

FIG. 13 is an end view of a semiconductor manufacturing line equipped with an auto-guided conveying device for conveying a wafer carrier according to the present invention;

FIG. 14 is an end view of the auto guided conveying device of FIG. 13 for conveying the wafer carrier;

FIG. 15 is a front view of the auto guided conveying device shown in FIG. 13;

FIGS. 16 is a perspective view of the vertical conveyer according to preferred embodiment of the present invention shown in FIG. 13;

FIG. 17 is a block diagram illustrating the control function of the auto guided conveying device shown in FIG. 13;

FIG. 18 is a perspective view showing another embodiment of the semiconductor manufacturing line of the present invention equipped with the auto guided conveying device for conveying the wafer carrier of FIG. 13;

FIG. 19 is an end view of an auto guided conveying device for conveying the wafer carrier according to another embodiment of the present invention; and

FIG. 20 is a front view of the auto guided conveying device for conveying the wafer carrier shown in FIG. 19.

### DETAILED D SCRIPTION OF THE PREFERRED EMBODIMENTS

The present invention now will be described more fully hereinafter with reference to the accompanying drawings, in which preferred embodiments of the invention are shown and described. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

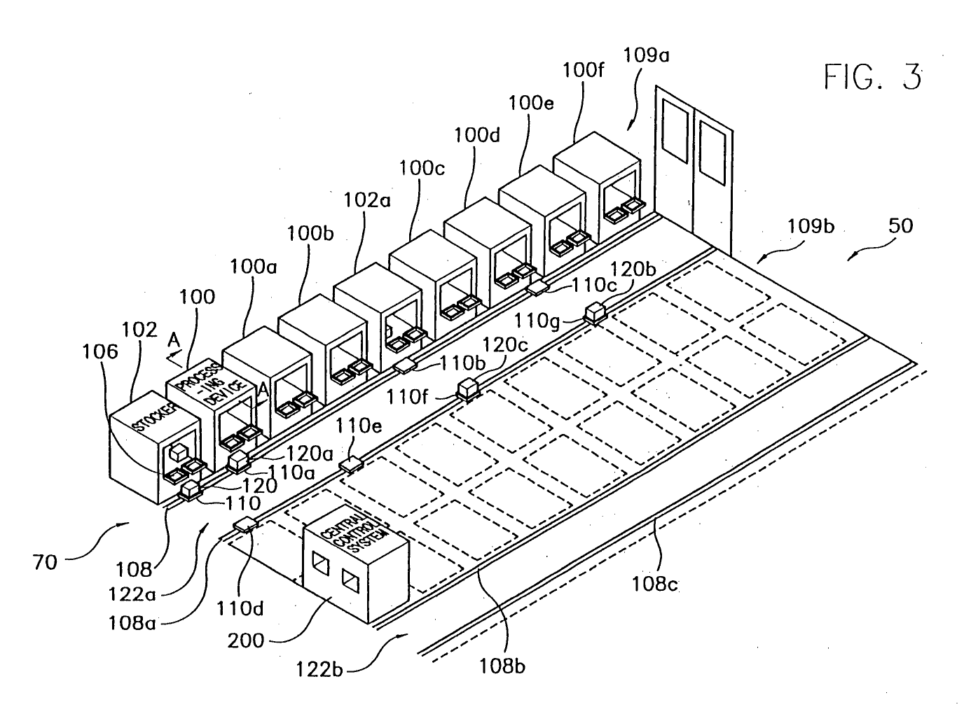

Referring now to the drawings, FIG. 3 illustrates an overall manufacturing system 50 that employs a transfer system 70 according to a preferred embodiment of the present invention. Within the facility 50, bays 122a and 122b provide space for a series of transfer shuttles 110 and working space for an operator. At the ends of the bays 122a and 122b, a plurality of stockers 102 are located; the stockers 102 (only one is illustrated herein) store containers, e.g., FOUPs 120, 120a, 120b and 120c, that retain the workpiece such as wafers. Processing devices 100, 100a, 100b, 100c, 100d, 100e and 100f are installed along the lengths of the bays 122a, 122b.

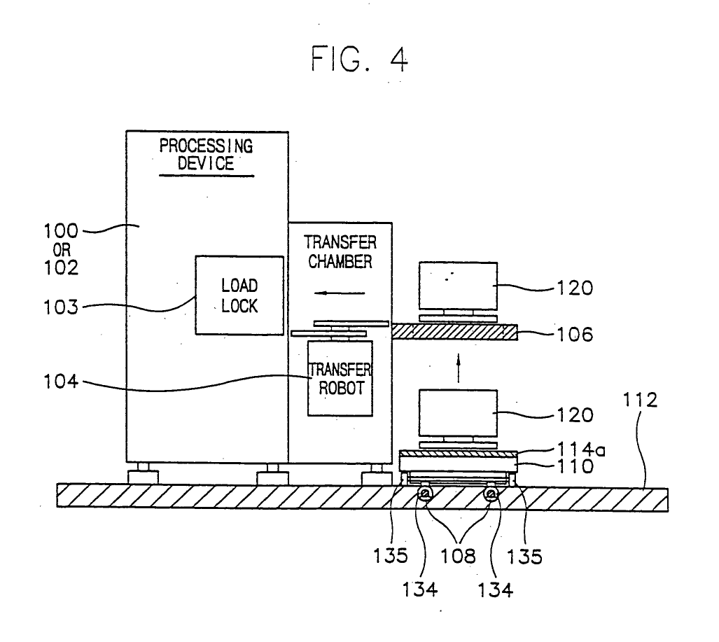

Guide rails 108, 108a, 108b and 108c extend along parallel paths on the floors of the bays 122a and 122b in front of the processing devices 100, 100a, 100b, 100c, 100d, 100e and 100f. The guide rails 108, 108a, 108b and 108c are positioned below a load port 106 (also known as an “index”) of each processing device. Each index 106 is configured to receive a device or container (a “FOUP”) that contains workpiece-like wafers. Exemplary guide rails include raised tracks, magnetic tape or the like. When magnetic tape is employed as the guide rail, it may be installed onto the bottom surface of the bay 122a along the traveling path under the load port. Alternatively, if a raised track is employed, (as is shown in FIG. 4 at 108), the bottom plane of the bay 122a may be slightly recessed along the traveling path to form a trench, and the track is installed within the trench as the guide rail 108. The floor of the clean room in a semiconductor factory is typically formed of grating; in such an instance, the grating is slightly recessed.

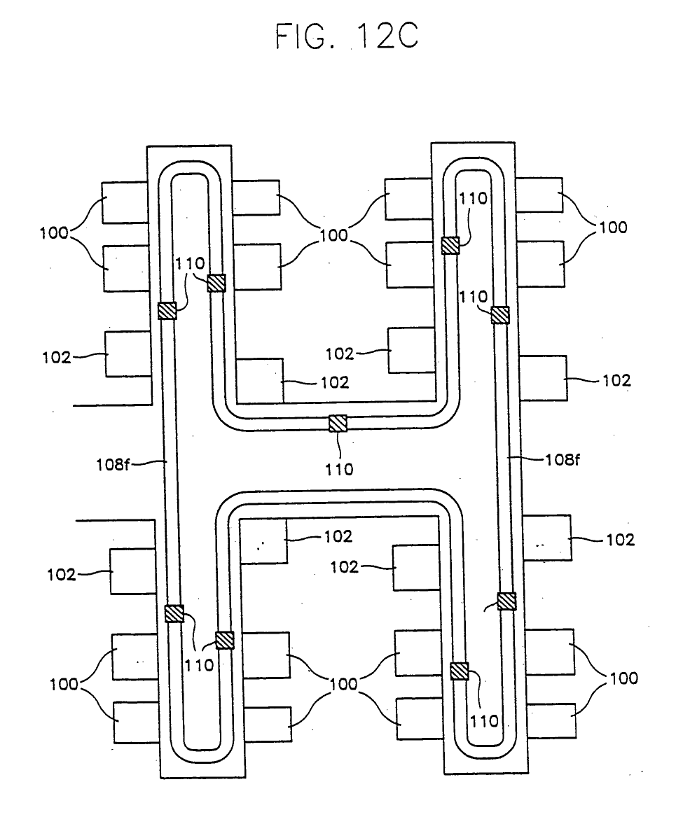

The arrangement of the guide rails 108 can be varied depending on the configuration of the facility 50. For example, as shown in FIG. 12A, the guide rails 108d may be installed to form separate tracks along both border sides of bays on which shuttles 110 reciprocate. Alternatively, as shown in FIGS. 12B and 12C, guide rails 108 may be installed to form a closed loop along both border sides of the bays (guide rails 108e) or along the edges of the sides of the bays arranged in an “H” shape (guide rails 108f).

Referring back to FIG. 3, a plurality of transport shuttles 110, 110a, 110b, 110c, 110d, 110e, 110f and 110g are positioned on the guide rail 108.

The transport shuttles respectively transmit their own position information, state information, and so on to a central control system 200 via wireless communication. The central control system 200 controls the travel and and loading/unloading operation of the shuttles. When the guide rail 108 is installed as an open loop, the transport shuttle linearly reciprocates between both ends of the guide rail 108. When the guide rail 108 is constructed as a closed loop,e.g., a circular loop, the transport shuttle may change direction to negotiate arcuate sections of the closed loop as well as traveling along a rectilinear path.

FIG. 4 illustrates the installation of a FOUP in a processing device 100. First, a FOUP 120 in the stocker 102 is transferred to the FOUP index 106 thereof and transferred onto the transfer shuttle 110. The loaded transfer shuttle 110 moves to one of several processing devices which contains photolithography equipment, deposition equipment, etching equipment, or the like. After the shuttle 110 loaded with the FOUP 120 has moved under the FOUP index 106 of the processing device 100 and loaded the FOUP 120 onto the FOUP index 106 (as will be described in detail below), a transfer robot 104 in the transfer chamber of the processing device 100 transfers wafers in the FOUP 120 to the load lock 103, where the processing device 100 acts on the wafers. After completing the process in the processing device 100, the transfer robot 104 returns the processed wafers from the load lock 103 to the FOUP 120 (as it is still positioned on the FOUP index 106). Both the above-described operation within the processing device and the operation of the transport shuttle 110 and loading/unloading operation of the FOUP 120 outside the processing device 100 are controlled via the wire/wireless communication with central control system 200.

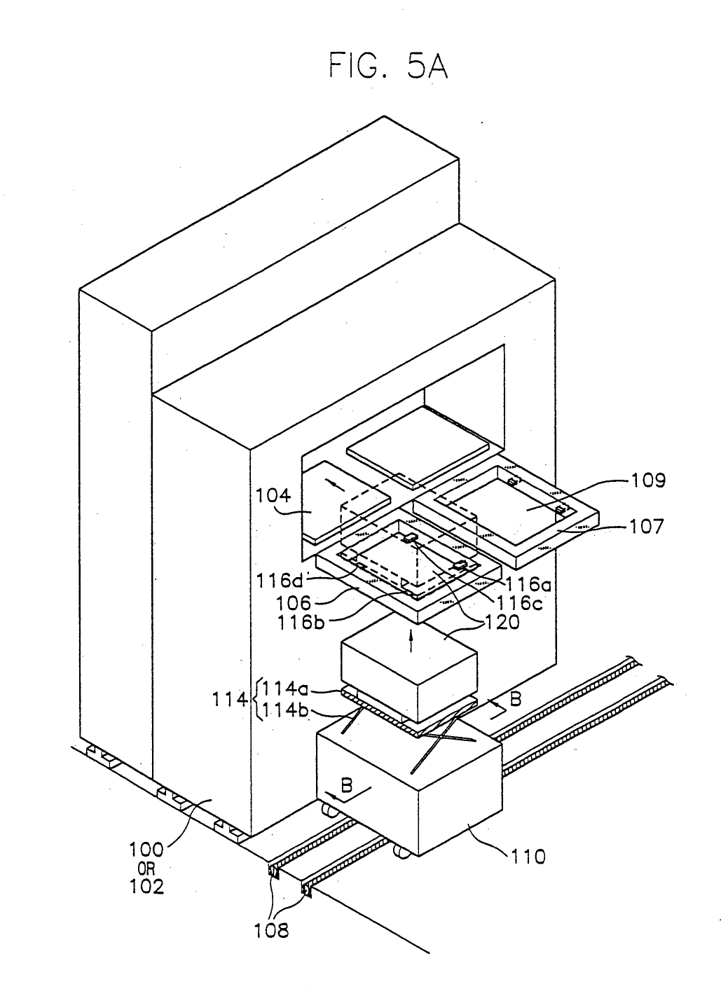

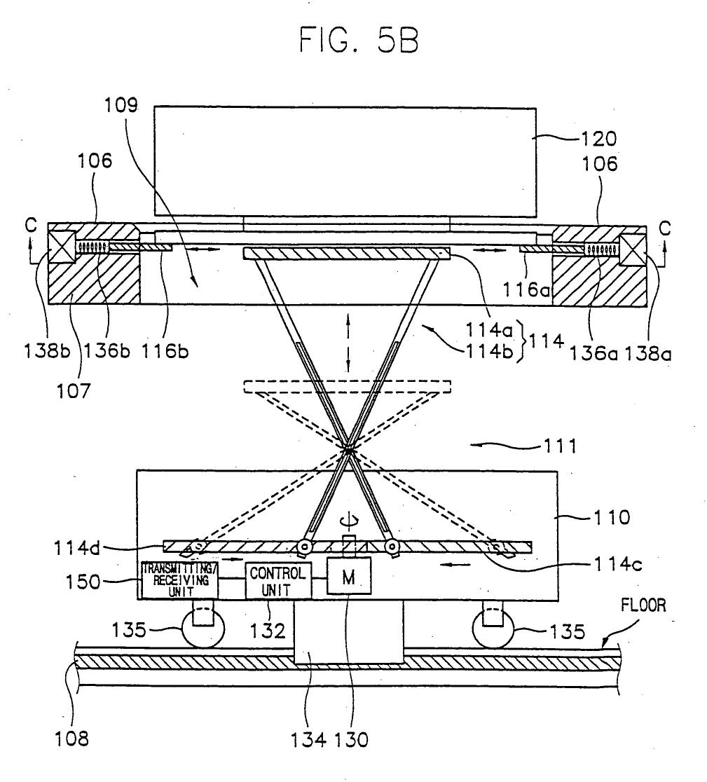

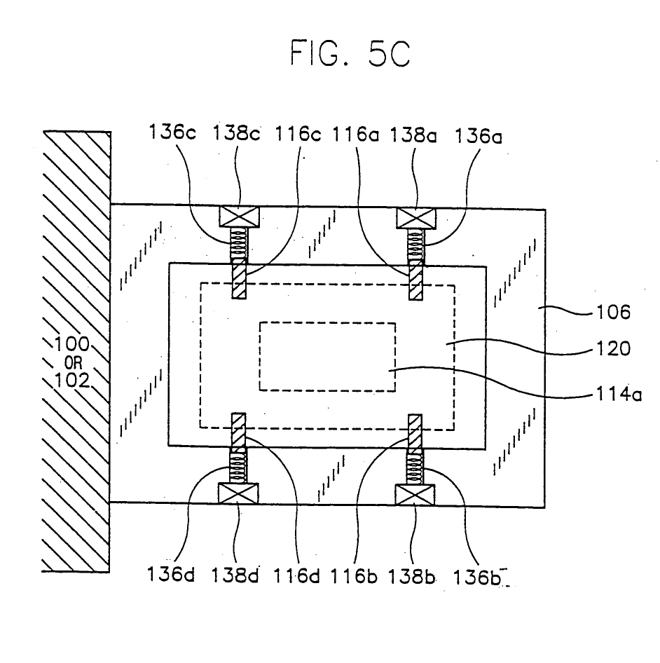

Referring now to FIGS. 5A and 5B, the transport shuttle 110 illustrated therein has a plurality of wheels 135 for rolling motion along the guide rails 108, a transmitting/receiving unit 150 for wirelessly communicating with the central control unit 200, and a control unit 132 for supplying the position information or traveling information thereof via transmitting/receiving unit 150 to the central control system 200. The form of the transport shuttle 110 may be varied depending on the configuration of the guide rails 108. For example, if the guide rail 108 is a track, the transport shuttle 110, as shown in FIG. 4 or FIGS. 5A and 5B, has a slide block 134 fitted onto the track 108 along the lower portion of the body thereof. In contrast, if magnetic tape is employed as the guide rail 108, the transport shuttle 110 should be equipped with sensing means (not shown) capable of recognizing the traveling path by sensing a magnetic field formed by the magnetic tape. Alternatively, controlling the movement of the transport shuttles 110 by a GPS (Global Positioning System) may permit the omission of the guide rail entirely.

Still referring to FIGS. 5A to 5C, the transport shuttle 110 also has a lifting member 111. which performs the vertical motion for loading/unloading the FOUP 120 onto/from the FOUP index 106. The lifting member 111 may take various forms. As shown in FIGS. 5A and 5B, in one embodiment the lifting member 111 is a foldable arm assembly driven by a motor. Included as parts of the lifting member are a support stand 114a for loading the FOUP 120 thereon, a motor 130, a pair of worm gear assemblies 114c and 114d rotatably coupled on the shaft of the motor 130, and a foldable arm assembly member 114b having lower end portions engaged with the pair of gear assemblies 114c and 114d, upper end portions coupled to the support stand 114a, and a center portion cross-coupled by a hinge. The length of the lower end portion of arm assembly 114b coupled to the gear assemblies 114c and 114d is increased or decreased in accordance with the rotative direction of the motor 130. By moving the lower end portion of the assembly 114b, the horizontal level of the support stand 114a descends or ascends.

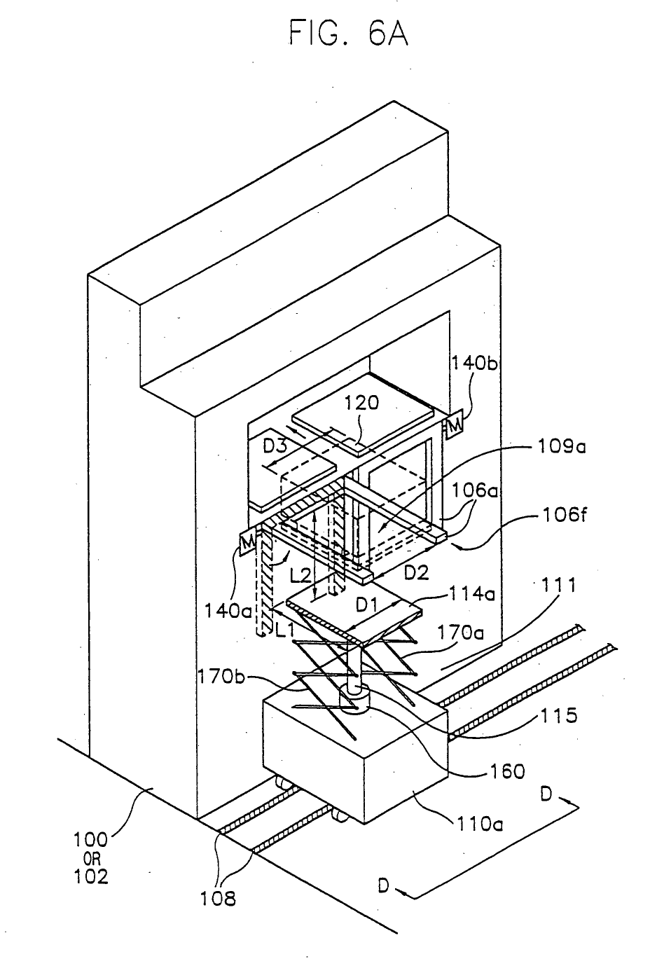

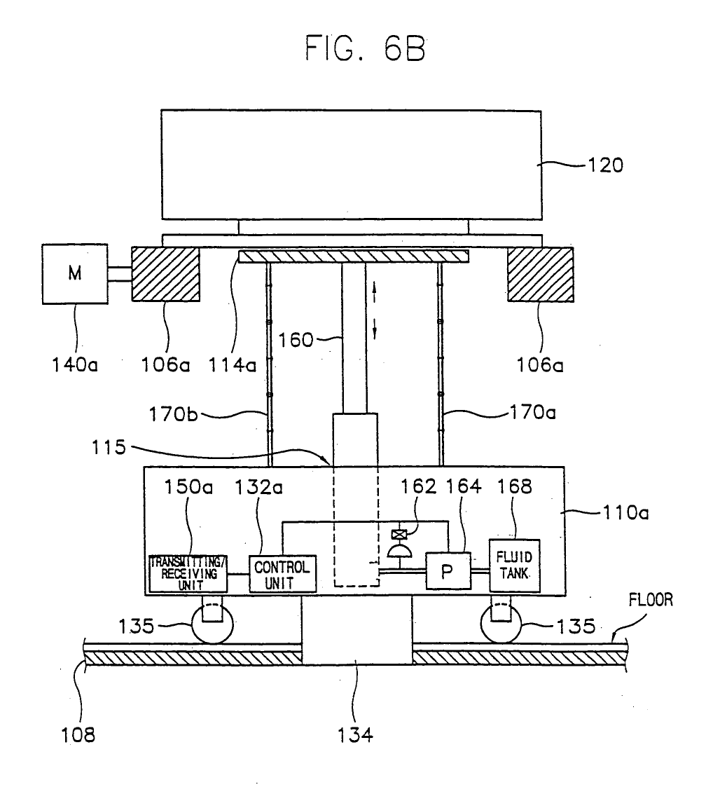

A second embodiment of the lifting member 111 (see FIGS. 6A and 6B) utilizes a hydraulic driving mechanism. The lifting member 111 according to the above system is formed by a support stand 114a for placing the FOUP 120 thereon, and a hydraulic cylinder assembly 115 coupled to allow an upper end portion thereof to suspend the support stand 114a. The hydraulic cylinder assembly 115 has a hydraulic cylinder 160, a valve 162 for controlling the fluid injection into the hydraulic cylinder 160, a fluid tank 168 for storing the fluid, and a hydraulic pump 164 for controlling the fluid flow between the fluid tank 168 and the hydraulic cylinder 160. The lifting member may be further augmented with a hinge-coupled foldable arm assembly 170a, 170b for assisting the horizontal balance of the support stand 114a. For reference, a controlling unit 132a and a transmitting/receiving unit 150a are shown in the drawings, in which the former is provided for controlling the opening/closing valve 162 or the operation of the hydraulic pump 164, while the latter cooperates with the wireless tranmission/reception with the central control system 200 as stated above. According to the foregoing construction, the controlling portion 132a controls the operation of hydraulic pump 164 and valve 162 based upon the loading/unloading information supplied via transmitting/receiving portion 150a to permit hydraulic cylinder 160 to move vertically.

Referring again to FIGS. 5A-5C, the FOUP index 106 should be configured such that the loading/unloading of the FOUP 120 is executed by the vertical motion of the lifting member 111. The FOUP index 106 has a rectangular ring-like supporting member 107 that is attached to the front wall of an entrance chamber to the processing device 100 and horizontally protrudes toward the bay 122a. The supporting member 107 has a center window 109 which allows the FOUP 120 to pass therethrough. Also, a plurality of supporting pins 116a, 116b, 116c, 116d protrude into and retract from the window 109 of the supporting member 107 to support the FOUP 120.

The supporting pins 116a, 116b, 116c, 116d are retracted during unloading/loading so as not to interfere with the movement of the FOUP 120 as it passes through the supporting member 107. The width and length dimensions of the window 109 of the supporting member 107 are larger than that of the FOUP 120 to allow the FOUP 120 to pass therethrough when the supporting pins 116a, 116b, 116c, 116d retract. Also, even when the supporting pins 116a, 116b, 116c, 116d are extended, the support stand 114a preferably has dimensions capable of passing through the window 107 without striking the extended supporting pins 116.

The mechanism for controlling the extension and retraction of the supporting pins 116a, 116b, 116c and 116d may be embodied by using mechanical or electromagnetic principles in several different ways. FIG. 5 illustrates, as one exemplary case, supporting pins 116a, 116b, 116c, 116d of a solenoid-driving system. Metallic supporting pins 116a, 116b, 116c and 116d are magnetically retracted toward the supporting member 107 by solenoids 138a, 138b, 138c and 138d. The pins 116a, 116b, 116c, 116d are extended to their original positions by springs 136a, 136b, 136c and 136d, which extend in the absence of any magnetization force supplied by the solenoids 138a, 138b, 138c, 138d.

Another embodiment of the present invention is illustrated in FIGS. 6A and 6B. In this embodiment, the FOUP index 106f is a U-shaped member with supporting arms 106a and an open center portion 109a. The supporting arms 106a are pivotally mounted to the front side wall of the entrance chamber.

Motors 140a and 140b permit the supporting arms 106a to rotate between a lowered position, in which they are parallel with the front side wall of the entrance chamber, and a raised position, in which they horizontally protrude toward the bay side. Movement between these positions corresponds with the up and down motion of the lifting member 111. A width D2 of the gap between the supporting arms 106a is narrower than a width D3 of the container 120 and wider than a width D1 of the support stand 114a. Upon the driving of motors 140a, 140b, the supporting arms 106a pivot to the lowered position as not to hinder the up and down motion of the lifting member when the lifting member ascends or descends under the state of loading FOUP 120 onto support stand 114a; otherwise, the supporting arms 106a horizontally protrude by being rotated by the motors 140a, 140b to the raised position.

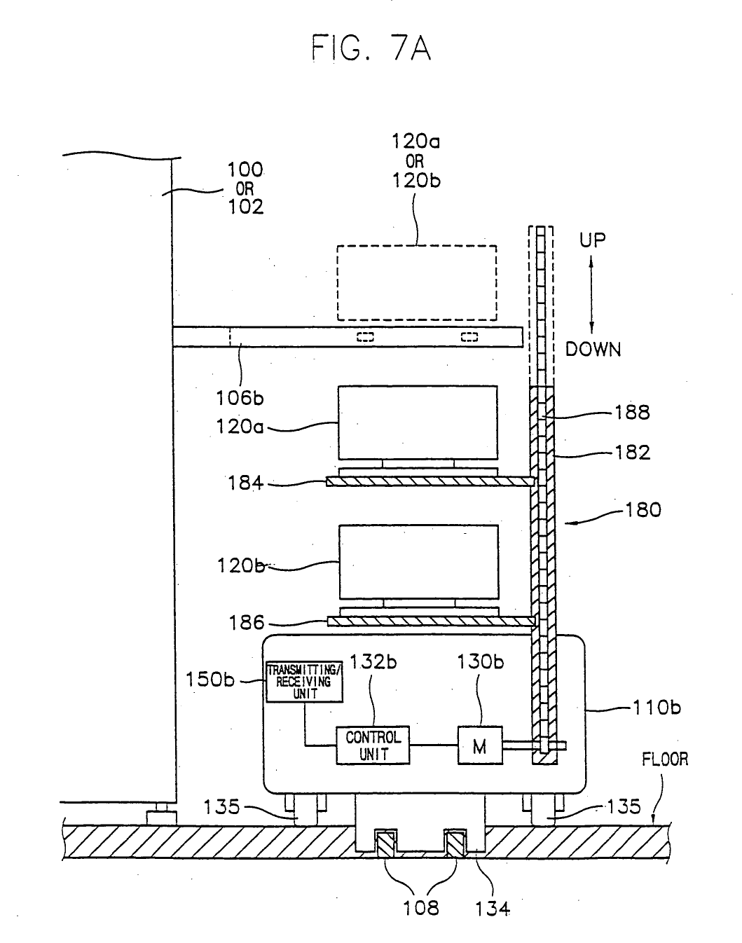

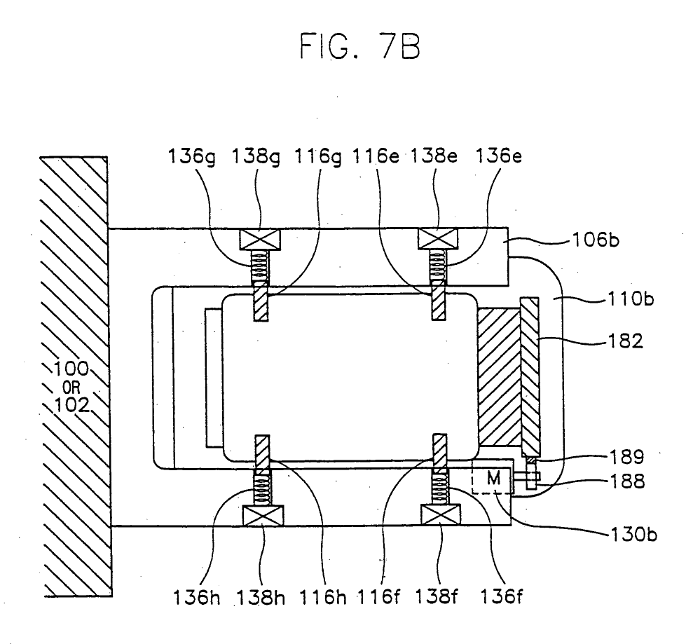

FIGS. 7A and 7B illustrate an embodiment of a transport shuttle 110b equipped with a vertically stacked support stand. The transport shuttle 110b includes a transmitting/receiving unit 150b, a controlling unit 132b and a slide block 134 that engages the vehicle 110b with a rail 108, each of which carry out the same function as those of the above-stated embodiment. As a characteristic feature, the lifting member 180 of the transport shuttle 110b has two support stands 184 and 186 that are vertically stacked, and an auxiliary plate 182 integrally coupled with the support stands 184 and 186 and a gear train 189 arranged along one corner at a prescribed interval. In addition, the lifting member 180 of the transport shuttle 110b includes a motor 130b for generating a rotative force under the control of control unit 132b, and a chain 188 brought into engagement with the gear train 189 of the auxiliary plate 182 to transmit the rotative force of the motor 130b to the auxiliary plate 182. Typically, since facility 100 or 102 is formed to have two FOUP indices at right and left sides, two FOUPs can be loaded or unloaded per visit once when the support stand has the illustrated and described vertically stacked structure, with the consequence of further increasing the efficiency of the operation.

Additionally, the FOUP index 106b, as shown in FIG. 7B, preferably adopts the U-shape illustrated in FIGS. 6A and 6B, which can facilitate the interaction of the FOUP index 106b with the ascending of the auxiliary plate 182. Supporting pins 116e, 116f, 116g and 116h are constructed to extend and retract by the reciprocal action of springs 136e, 136f, 136g and 136h and solenoids 138e, 138f, 138g and 138h as described above.

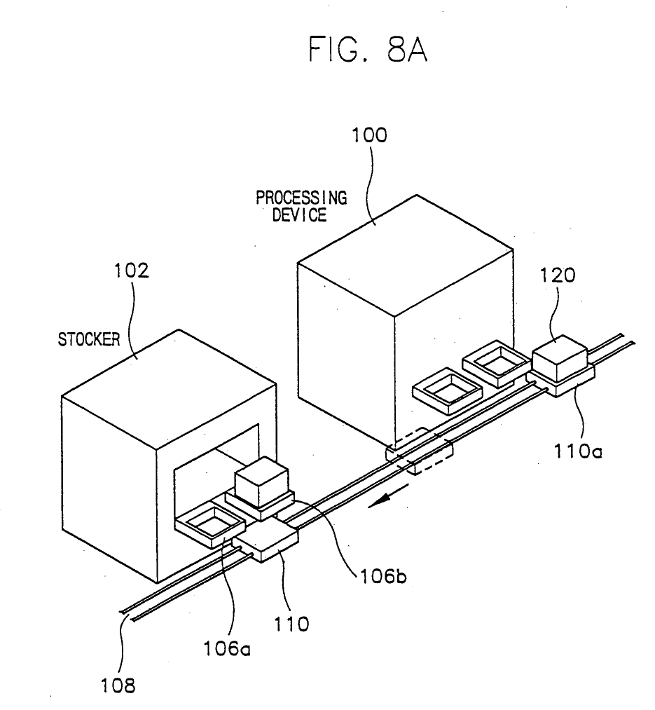

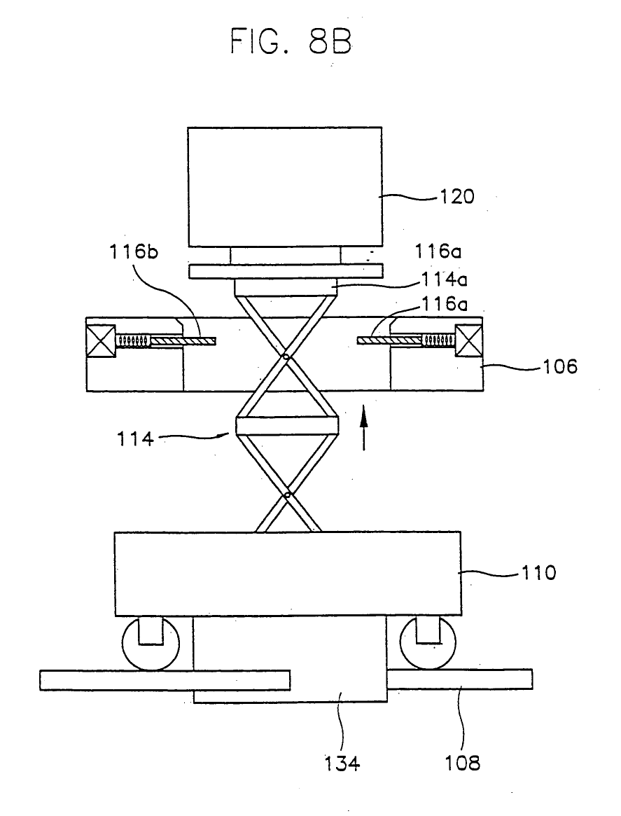

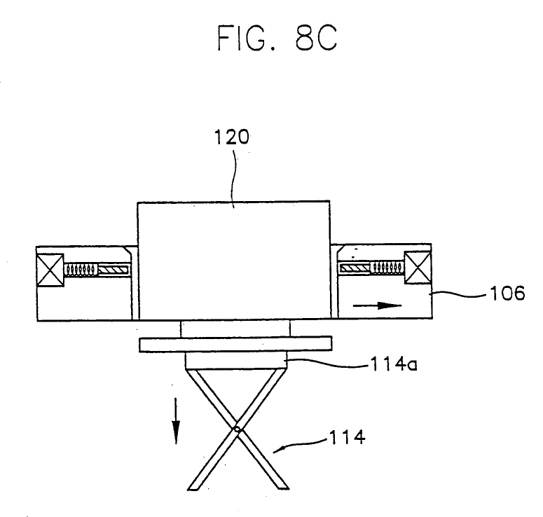

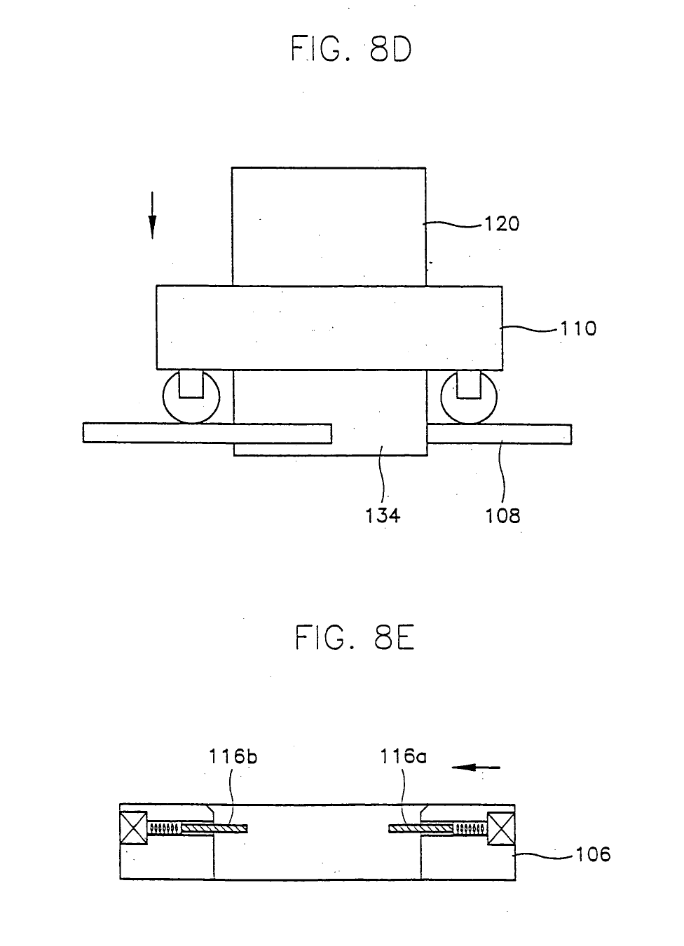

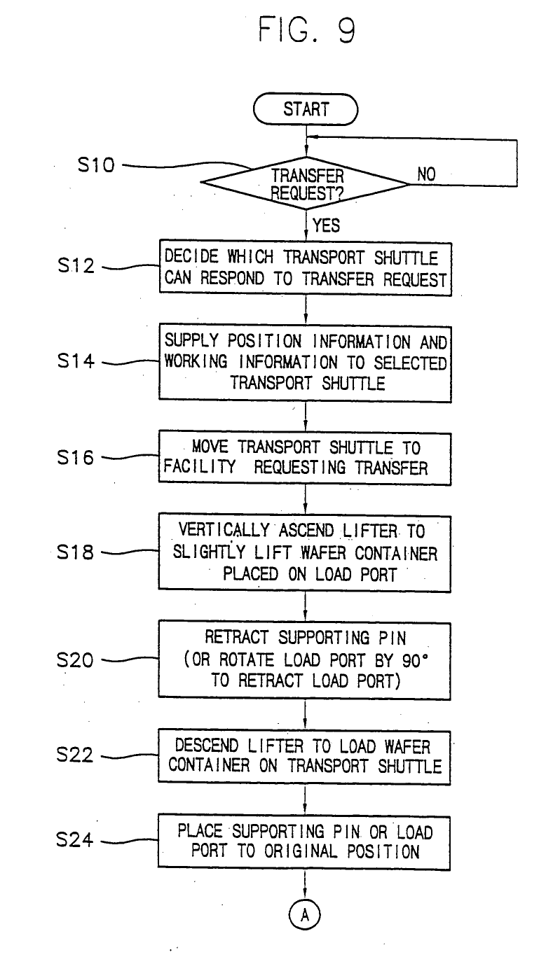

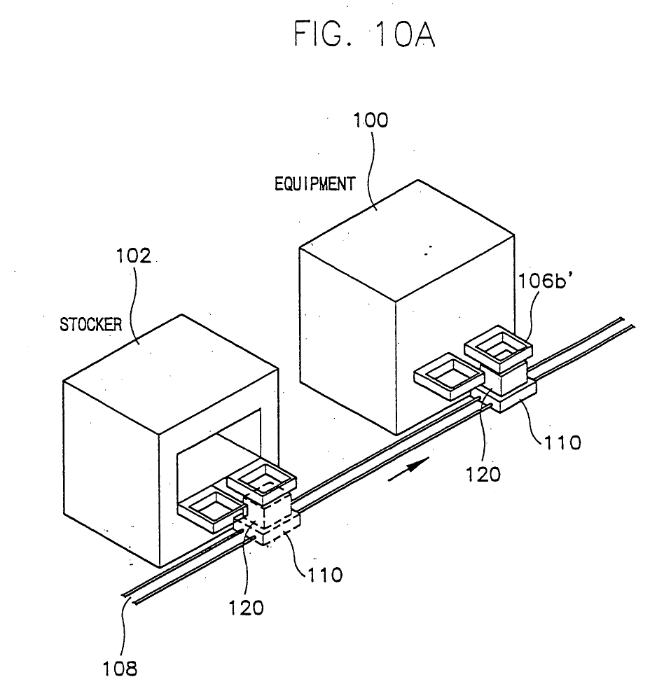

The loading process of a FOUP 120 will be described with reference to FIGS. 8A, 8B, 8C, 8D and 8E and FIG. 9. “Loading” refers to the operation of transferring the FOUP 120 to be subjected to processing from a wafer storing device, i.e., the stocker 102, or a processing device 100, onto a shuttle 110, or refers to the operation of transferring the FOUP completely-processed in the processing device 100 to the stocker 102 from the processing device 100.

The loading operation is performed as follows. First, a selected transport shuttle 110 under the duty-off state is moved to the right bottom of the FOUP index 106b of the facility 102 which requests the shuttle 110. In performing this action, the central control system 200 determines which transport shuttle 110 is to respond to the above traveling request. The central control system 200 analyzes individual position information supplied from the plurality of transport shuttles 110 and transfer request information, including information about the departure and arrival positions supplied from the facility 102 which requests the operation, and thereby selects a single transport shuttle for responding to the transfer request (typically the shuttle 110 capable of responding the most efficiently). Thereafter, the central control system 200 provides information regarding the position of the facilities and the operation to be performed, (i.e., loading operation or unloading operation) to the selected transport shuttle 110. The transport shuttle 110 that receives the foregoing movement and operation instruction is moved along guide rail 108 to a position below the FOUP index 106b of the facility that requests the operation (FIG. 8A, steps S10, S11, S12, S13, S14, S15 and S16).

Once in position below the FOUP index 106b of the facility 102, the transport shuttle 110 raises the lifter 114 to slightly lift the container 120 positioned on the FOUP index 106 to an elevated position (FIG. 8B, step S18). Then, the solenoids 138a, 138b, 138c and 138d are magnetically activated to retract the supporting pins 116a, 116b, 116c and 116d that support the container 120 to a position inside of the supporting member 106a (in the case of the FOUP index according to the embodiments shown in FIGS. 6a and 6b, the motor 140a is driven to rotate the supporting member 106a downwardly to be parallel with the front side wall of the entrance chamber). Thereafter, the lifter 114 lowers to place the FOUP 120 on the transport shuttle 110 (FIGS. 8C and 8D, steps S20 and S22). Thereafter, the solenoids 138a, 138b, 138c and 138d are deactivated (or the motor 140a is stopped) to return the supporting pins 116a, 116b, 116c and 116d or the supporting member 106a to their original positions (FIG. 8E, step S24).

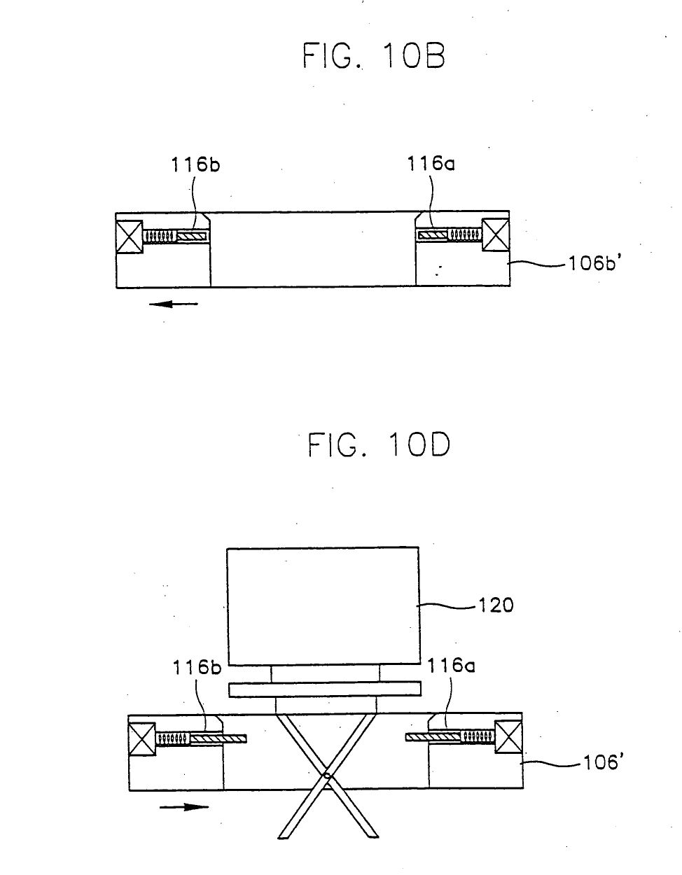

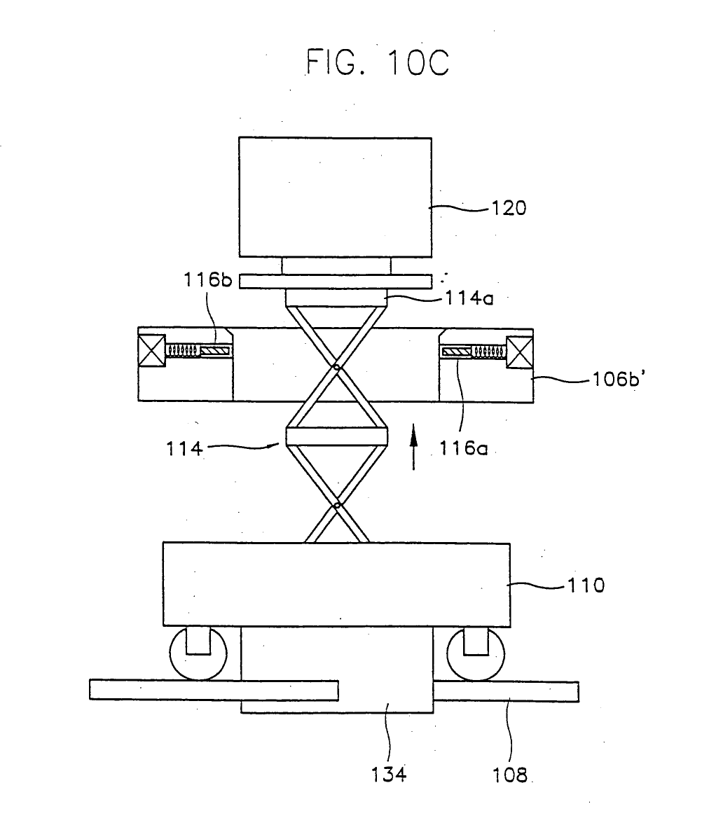

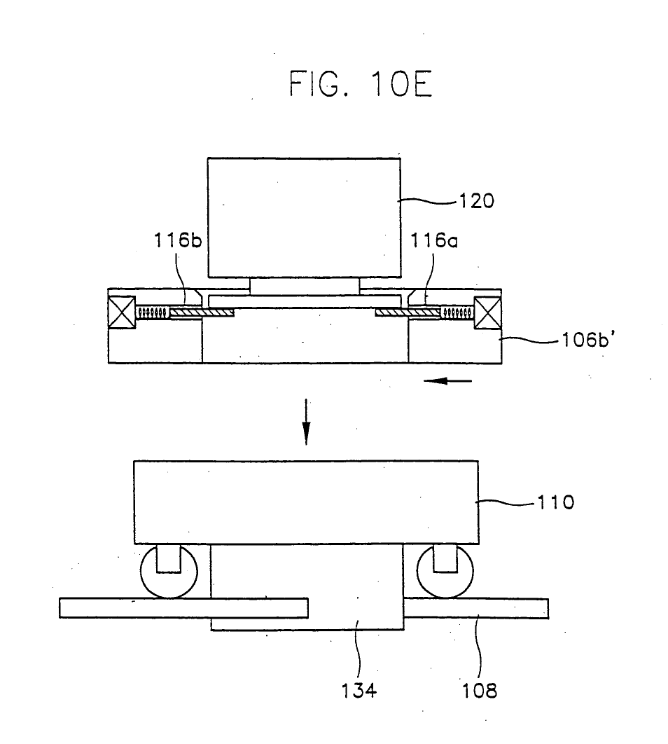

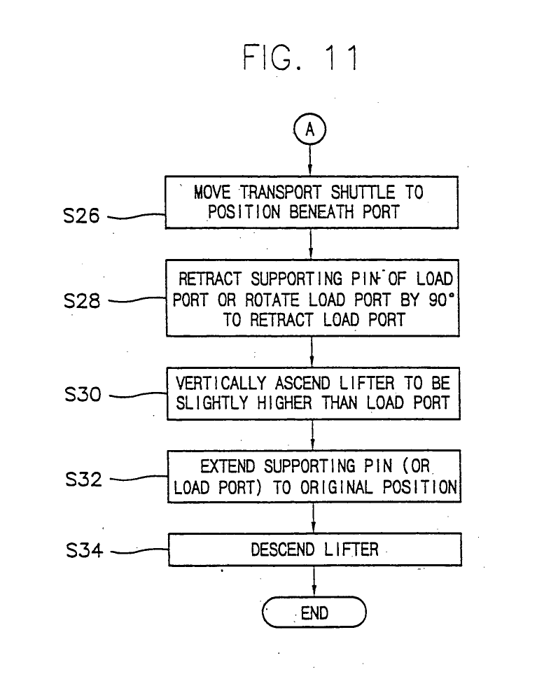

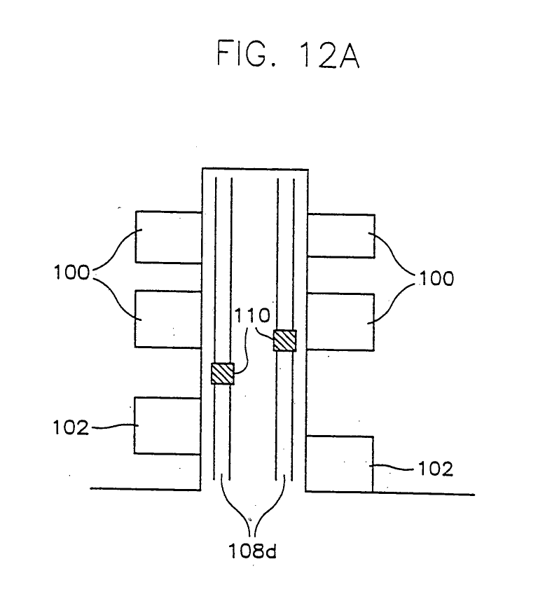

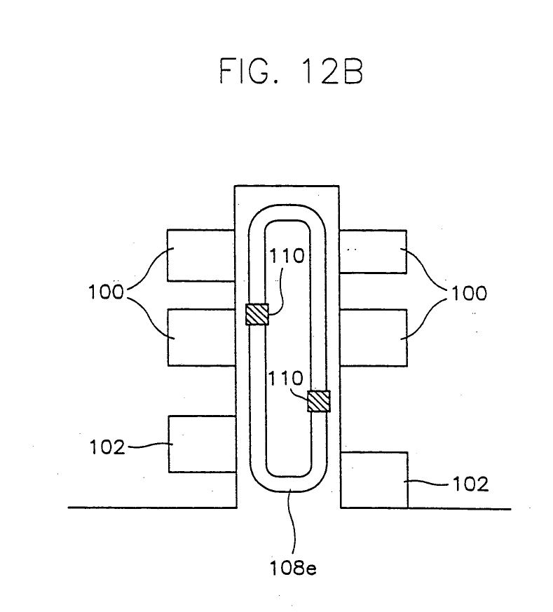

Referring now to FIGS. 10A, 10B, 10C, 10D and 10E and FIG. 11, the process of unloading a FOUP 120 will be described. “Unloading” refers an operation in which, conversely to loading, the FOUP 120 to be subjected to the processing operation is transferred from a transport shuttle 110 to a processing device 100, or in which a completely-processed FOUP 120 is transferred from a transport shuttle 110 to a stocker 102.

Initially, the transport shuttle 100 with the FOUP 120 is moved to a position below the the FOUP index 106b′ of a facility 100 designated by the central control system 200 (FIG. 10A, step S26).

After confirming the arrival of the transport shuttle 110, the FOUP index 106b′ magnetically activates the solenoids 138a, 138b, 138c, 138d, thereby retracting the supporting pins 116a, 116b, 116c and 116d (or, in the case of the FOUP index according to the embodiment shown in FIGS. 6A and 6B, the supporting arms 106a, 106b are rotated to their lowered position). (FIG. 10B, step S28). Subsequently, the lifter 114 vertically raises the FOUP support stand 114a loaded with the FOUP 120 thereon to an elevated position that is slightly higher than the horizontal level of the FOUP index 106b′ (FIG. 10C, step S30). After this operation, the solenoids are deactivated, thereby extending the supporting pins 116a, 116b, 116c and 116d to their original positions (or power is supplied to the motor 140a to place the supporting member 106a in its original lowered position) (FIG. 10D, step S32). Finally, the lifter 114 descends to allow the FOUP 120 to be loaded on the FOUP index 106b′ supported by the supporting pins 116a, 116b, 116c and 116d (FIG. 10E, step S34).

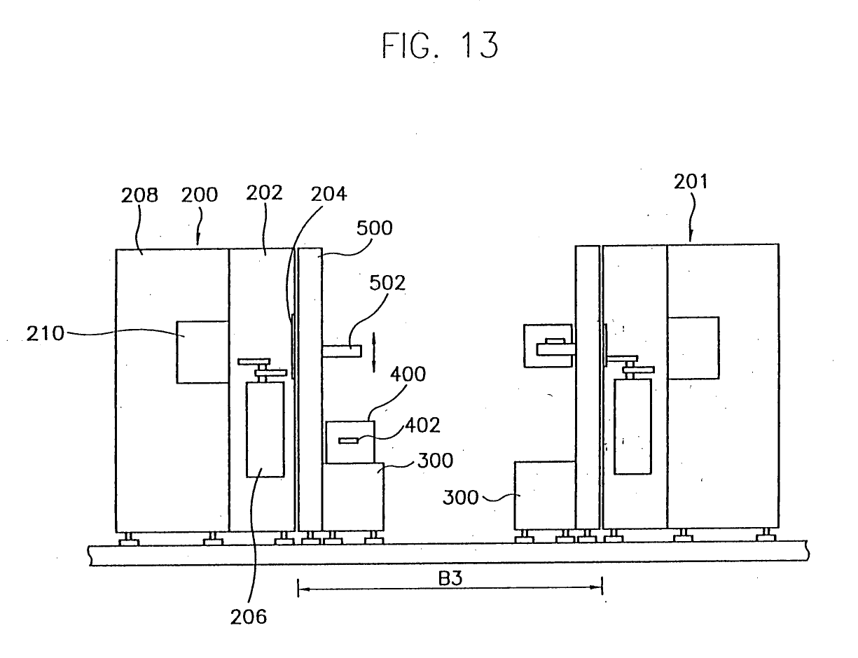

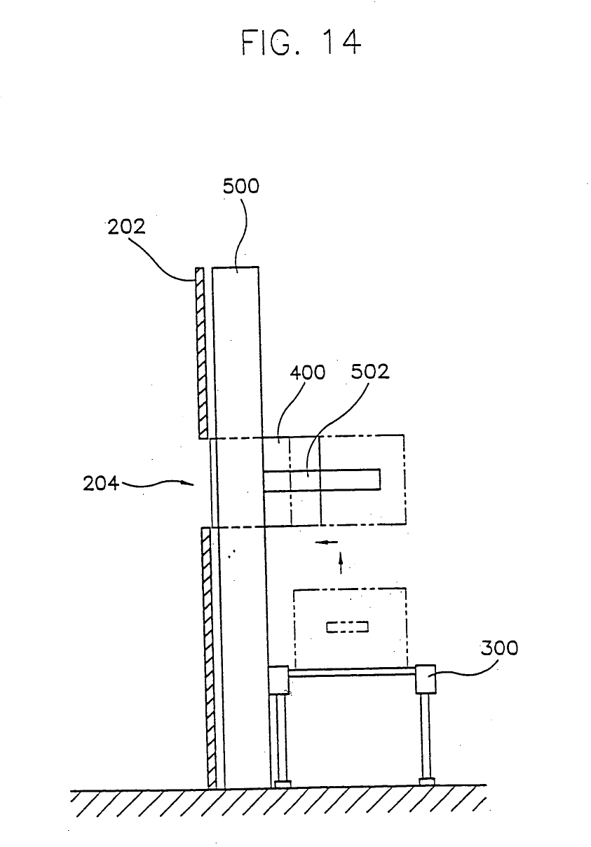

Hereinafter, another embodiment of the present invention will be described. FIGS. 13 and 14 show a semiconductor manufacturing line 200 equipped with an auto guided conveying device for conveying the wafer carrier according to the present invention. A bay B3 is installed in a clean room to provide the working space for the auto guided conveying device and the operator. A plurality of stockers for storing containers having wafers, such as FOUPs, or wafer processing equipment 201 are installed on both sides of the bay B3 in line with each other. The wafer processing equipment 201 includes an inlet chamber 202 formed at a front center portion thereof with a wafer inlet 204 and a process chamber 208 having a load lock 210. A conveying robot 206 is installed in the inlet chamber 202. The conveying robot 206 receives a wafer from a wafer carrier 400 installed at the wafer inlet 204 and transfers the wafer to the loadlock 210, or transfers the wafer from the loadlock 210 to the wafer carrier 400.

A sliding roller conveyer 300 is installed at a bottom of the bay B3. The sliding roller conveyer 300 is positioned at a space formed below a FOUP index 502 which protrudes forwardly from the wafer processing equipment 201. The height of the sliding roller conveyer 300 is lower than the height of the wafer inlet 204 in such a manner that, when one wafer carrier 400 resides in the wafer inlet 204, another wafer carrier 400a can be passed without making contact with the waiting wafer carrier 400.

A vertical conveyer 500 is installed between the inlet chamber 202 and the sliding roller conveyer 300 that can move the wafer carrier 400 conveyed by the conveyer up to the wafer inlet 204. The vertical conveyer 500 has a pair of gripping arms 502 which move vertically along the vertical conveyer 500. Accordingly, the depth of the vertical conveyer 500 is relatively small as compared with a conventional FOUP index. Since the wafer carrier supporter is not present in this embodiment, the bay B3 has sufficient space for use.

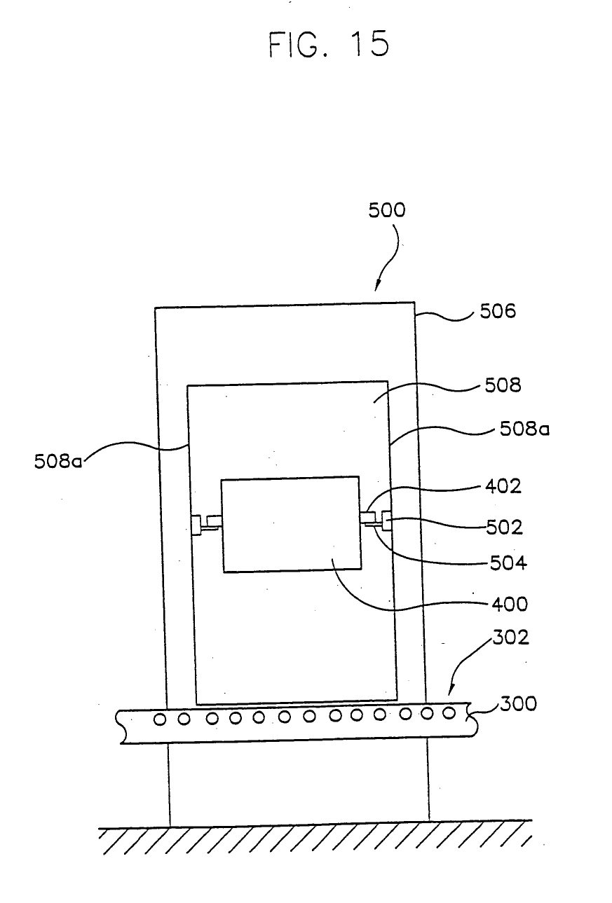

As shown in FIG. 15, the wafer carrier 400 has projections 402 protruding from both sides thereof. The projections 402 are supported by supporting brackets 504 of gripping arms 502. With this configuration, the undersides of the projections can be horizontally maintained.

The vertical conveyer 500 has a rectangular housing 506 with a working space 508 therein. The working space 508 extends from a conveying surface 302 of the conveyer 300 to the wafer inlet 204. The gripping arms 502 are installed at both side walls 508a of the working space 508, and the gripping arms 502 and the wafer carrier 400 are conveyed within the working space 508.

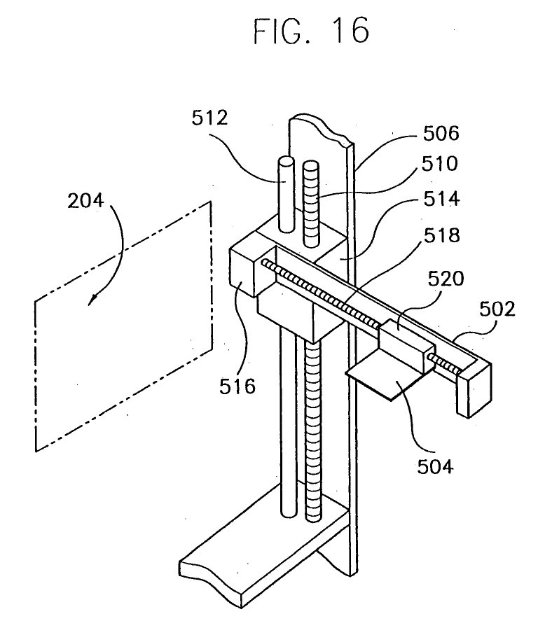

Referring now to FIG. 16, one half of the symmetrically-formed vertical conveyer 500 is illustrated. As shown in FIG. 16, a conveying screw 510, which is a z-axis (vertical) conveying device, extends vertically along an inner surface of the housing 506. A guiding member 512 is installed in parallel to the conveying screw 510. The guiding member 512 comprises a smooth rod and guides a block 514 such that the block 514 can slide thereon when the block 514 moves up and down. The block 514 is cooperatively threaded to the conveying screw 510 so that the block 514 moves up when the conveying screw 510 rotates in a forward direction and moves down when the conveying screw 510 rotates in a reverse direction.

The conveying screw 510 rotates in forward and reverse directions when driven by a motor (not shown). A driving/driven gear combination can be installed between a rotating shaft of the motor and the conveying screw 510 so as to reduce the moving speed of the moving member 514.

The gripping arm 502 is fixed to an inner side of the block 514. Accordingly, the gripping arm 502 also moves when the block 514 moves up and down. The gripping arm 502 protrudes beneath the projection 402 of the wafer carrier 400, which is conveyed from the front portion of the wafer processing device through the conveyer 300. The gripping arm 502 includes a y-axis (horizontal) conveying device 518, such as a conveying screw, for conveying the wafer carrier 400 in a y-axis direction and a y-axis block 520 which is conveyed in the y-axis direction by the y-axis conveying device 518. The y-axis block 520 has a supporting bracket 504 for supporting the projection 402 of the wafer carrier 400. A motor and a gear box 516 installed at a rear portion of the gripping arm 502 rotate the y-axis conveying device 518. Through the rotation of the y-axis conveying device 518, the y-axis block 520 moves in the forward and backward directions. The supporting bracket 504 attached to the y-axis block 520 moves in the forward and backward directions within the length of the gripping arm 502 so that the supporting bracket 504 is positioned below the projection 402 of the wafer carrier 400.

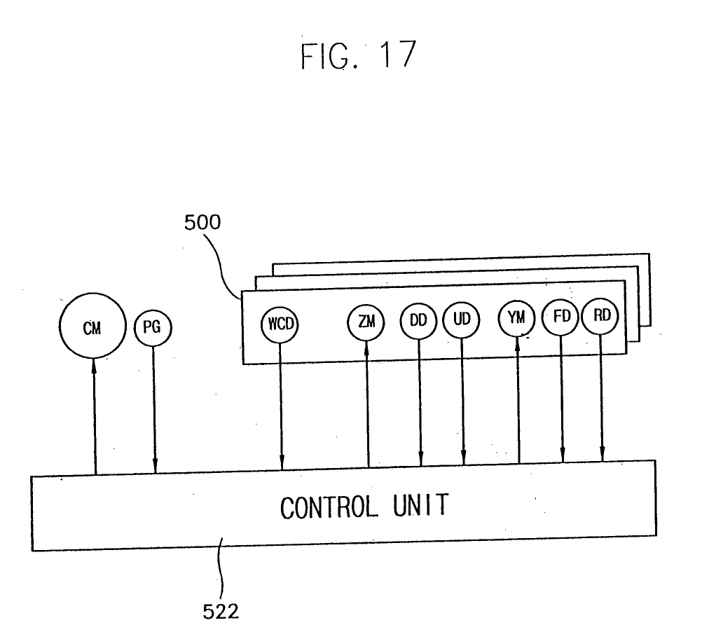

The control function of the auto guided conveying device 200 is shown in FIG. 17. A controller 522 of the auto guided conveying device 200 controls the movement of the wafer carrier 400 of the conveyer 300 through a motor CM, a pulse generator for detecting the rotational speed of the motor CM and an encoder PG. In addition, the controller 522 is connected to vertical conveyers 500 installed in the wafer processing equipment 201 so as to control the conveying of the FOUP.

A wafer carrier detector WCD is installed at a front portion of the wafer processing equipment 201 so as to detect the wafer carrier 400 when the wafer carrier 400 reaches a predetermined position. When the wafer carrier 400 is not detected, the y-axis moving member 520 is positioned at a rear position and the gripping arm 502 is positioned at an uppermost position through a z-axis motor ZM and y-axis motor YM. The rear position is detected by a rear detector RD and the uppermost position is detected by an upper detector UD.

When the wafer carrier 400 is detected by the wafer carrier detector WCD, the y-axis block 520 moves down to a lowest position by using a lowest position detector DD. When the wafer carrier 400 reaches the lowest position, the y-axis block 520 moves up to a front position by using a front detector FD.

As the y-axis block 520 moves to the front position, the wafer carrier 400 positioned in the front position is engaged by the gripping arm 502. When this occurs, the z-axis motor ZM rotates in the reverse direction so that the gripping arm 502 moves up to the uppermost position. When the gripping arm 502 reaches the uppermost position, the y-axis block 520 is moved so as to convey the wafer carrier 400 to the rear position.

The downward movement of the wafer carrier 400 is carried out by reversing to the aforementioned upward movement of the wafer carrier 400.

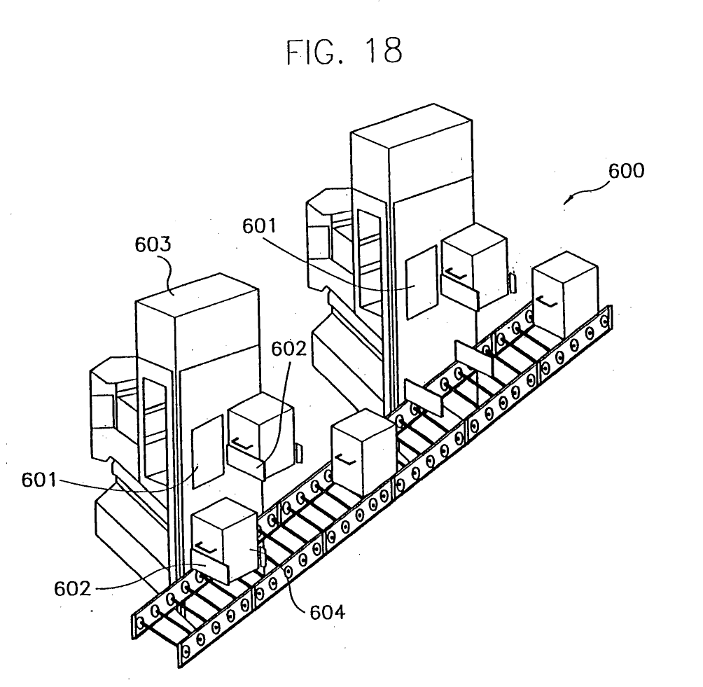

Referring now to FIG. 18, another embodiment of the semiconductor manufacturing line 600 equipped with the auto guided conveying device for conveying a wafer carrier is illustrated therein. In FIG. 18, two wafer inlets 601 and two vertical conveyers 602 are installed on one device 603. According to this embodiment, two vertical conveyers 602 can be alternatively or simultaneously operated so that the speed of the up/down operation of the wafer carrier 604 can be increased twofold.

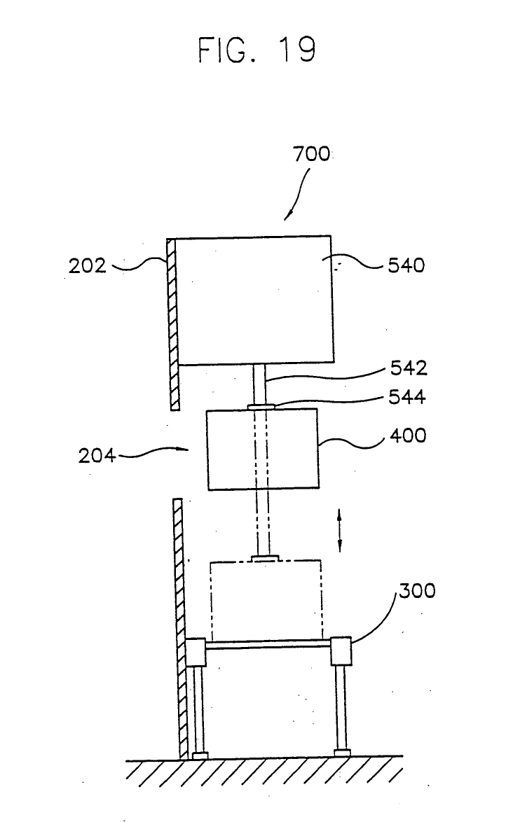

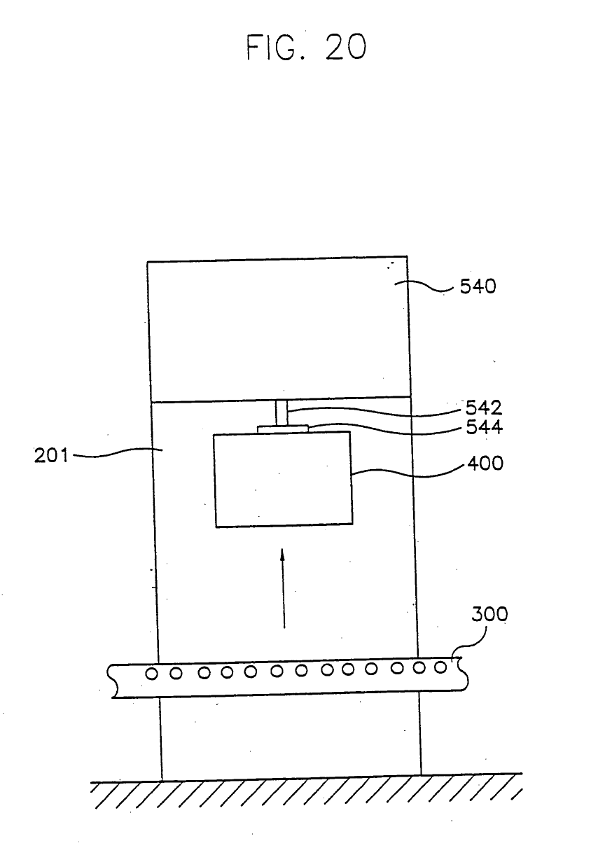

Referring now to FIGS. 19 and 20, an auto guided conveying device 700 for conveying a wafer carrier 400 according to another embodiment of the present invention is illustrated. In this embodiment, an upper portion of the wafer carrier 400 is gripped by using a vacuum suction head 544. Accordingly, space for a vertical conveyer is not required at a lower center area in front of the processing station so that the space of the bay can be efficiently used.

The housing 541 of the vertical conveyer 540 is installed on an upper front portion of the wafer inlet. A gripping rod 542 extending from a bottom surface of the housing 541 is provided with the vacuum suction head 544. The vacuum suction head 544 applies suction to an upper surface of the wafer carrier 400 so as to pick up the wafer carrier 400. The gripping rod 542 can be installed in the housing such that it can moves in the y-axis (horizontal) direction.

While the present invention has been described in detail with reference to the preferred embodiment thereof, it should be understood to those skilled in the art that various changes, substitutions and alterations can be made hereto without departing from the scope of the invention as defined by the appended claims.

For example, the z-axis conveying device can be constructed with a linear motor having a stator rail and a rotor or with a hydraulic or pneumatic cylinder and a piston rod. When the z-axis conveying device is constructed by a linear motor, the gripping arm or gripping rod can be fixed to the rotor. When the z-axis conveying device is constructed with a hydraulic cylinder and a piston rod, the gripping arm can be fixed to an end portion of the piston rod.

The structure of the y-axis conveying device can be variously changed in the same manner as the z-axis conveying device. The structures of the y-axis conveying device and the z-axis conveying device can be formed by combining the above elements or by combining various reciprocating mechanisms.

As described above, the present invention can utilize airtight characteristics of the FOUP. A non-airtight wafer container (i.e., open-type wafer cassette) is may be undesirable due to its being vulnerable to contaminating material, as the transferring operation is performed at the lower portion of the FOUP index.

As can be seen from the foregoing, the present invention allows the guide rail to be placed along the lower portion of a FOUP index to enhance the approach and stability with respect to the processing device of the operation. The multi-axial robot having been required in the AGV system is unnecessary; the simple lifter that is capable of performing vertical motion can simplify the apparatus. Because the transport shuttle travels by utilizing the lower space of the FOUP index, the width of the bays can be reduced to improve the device compactness or space utilization while lowering the maintenance cost. Furthermore, a working space capable of providing simultaneous operation with the worker can enable the execution of manual operations in case of a state of emergency, such as electrical power failure or interrupted operation.

While the present invention has been particularly shown and described with reference to particular embodiment thereof, it will be understood by those skilled in the art that various changes in form and details may be effected therein without departing from the spirit and scope of the invention as defined by the appended claims.

What that which is claimed is:

1. An apparatus for conveying a wafer container to a plurality of wafer processing stations, said processing stations being aligned in an x-axis direction and having a wafer inlet, said apparatus comprising:
a horizontal conveyor positioned adjacent and below the wafer inlet of each processing station and extending in the x-direction;
a vertical conveyor positioned adjacent the wafer inlet of each processing station and being configured to convey the wafer container substantially vertically along a z-axis between a position on the horizontal conveyor and the wafer inlet; and
a controller operably associated with said horizontal and vertical conveyors to control the position of the wafer container.

2. The apparatus defined in claim 1, wherein said horizontal conveyor comprises a roller conveyor.

3. The apparatus defined in claim 1, wherein said vertical conveyor comprises:
a hollow housing positioned forward of the wafer inlet having side walls;
a pair of vertical translation members located on respective housing side walls; and
a pair of gripping arms mounted for vertical movement on respective vertical translation members and extending toward each other.

4. The apparatus defined in claim 3, wherein said vertical translation members comprise conveying screws, and wherein said gripping arms are threadedly coupled to respective ones of said conveying screws.

5. The apparatus defined in claim 3, wherein said vertical translation members comprises hydraulic piston assemblies, each of said hydraulic piston assemblies including an extensible piston rod, and wherein said gripping arms are mounted to a respective piston rod.

6. The apparatus defined in claim 3, further comprising a y-axis conveying device for conveying the container along a y-axis from a position forward of the wafer inlet into the wafer inlet.

7. The apparatus defined in claim 1, wherein said vertical translation device comprises a suction head configured to apply suction to an upper surface of said container.

8. A method of loading a wafer container into one of a plurality of wafer processing stations, said processing stations being aligned in a horizontal x-axis direction and having a wafer inlet, said method comprising the steps of:
conveying the wafer container to a position below a wafer inlet and adjacent a loading apparatus;
conveying gripping arms of the loading apparatus to a lowered position below said wafer container;
gripping said wafer container with said gripping arms; and
raising said wafer container to a raised position at a level at least as high as the wafer inlet.

9. The method defined in claim 8, further comprising the step of conveying the container in a horizontal y-axis direction into said wafer inlet.

10. An apparatus for conveying a wafer container to a plurality of wafer processing stations, said processing stations being aligned in an x-axis direction and having a wafer inlet, said apparatus comprising:
a horizontal conveyor positioned adjacent and below the wafer inlet of each processing station and extending in the x-direction;
a vertical conveyor mounted to the processing station and positioned adjacent the wafer inlet of each processing station and being configured to convey the wafer container substantially vertically along a z-axis between a position on the horizontal conveyor and the wafer inlet; and
a controller operably associated with said horizontal and vertical conveyors to control the position of the wafer container.

11. The apparatus defined in claim 10, wherein said horizontal conveyor comprises a roller conveyor.

12. The apparatus defined in claim 10, wherein said vertical conveyor comprises:
a hollow housing positioned forward of the wafer inlet having side walls;
a pair of vertical translation members located on respective housing side walls; and
a pair of gripping arms mounted for vertical movement on respective vertical translation members and extending toward each other.

13. The apparatus defined in claim 12, wherein said vertical translation members comprise conveying screws, and wherein said gripping arms are threadedly coupled to respective ones of said conveying screws.

14. The apparatus defined in claim 12, wherein said vertical translation members comprises hydraulic piston assemblies, each of said hydraulic piston assemblies including an extensible piston rod, and wherein said gripping arms are mounted to a respective piston rod.

15. The apparatus defined in claim 12, further comprising a y-axis conveying device for conveying the container along a y-axis from a position forward of the wafer inlet into the wafer inlet.

16. The apparatus defined in claim 10, wherein said vertical translation device comprises a suction head configured to apply suction to an upper surface of said container.
